(19) United States
(12) Patent Application Publication
(10) Pub. No.: US 2010/0198882 A1
(43) Pub. Date: Aug. 5, 2010

(54) Systems and methods for creating multiple logbooks in a computer application.

(76) Inventor: Roshan B. Shrestha, Glastonbury, CT (US)

Correspondence Address: Roshan Shrestha, 46 Barrington Way, Glastonbury, CT, 06033, US

(21) Appl. No.: 12/651,427

(22) Filed: Dec. 31, 2009

Related U.S. Application Data
(60) Provisional application No. 61/148,988, filed on Feb. 1, 2009.

(51) Int. Cl. G06F 17/30

(52) U.S. Cl. 707/803; 707/E17.044

(57) ABSTRACT

Systems and methods for creating multiple logbooks in a computer application. Entities that make up the components of a logbook are defined. The logbook is customized by further extending the entities and defining the relationship between the entities. Using the entities and their extensions and relationships, multiple logbooks can be created in a single computer application.

### CROSS-REFERENCE TO RELATED APPLICATIONS

This application claims priority of U.S. Provisional Application No. 61148988 filed on Feb. 1, 2009 entitled Systems and methods for creating multiple different logbooks in a single software application by Roshan Shrestha.

### FEDERALLY SPONSORED RESEARCH OR DEVELOPMENT

Not Applicable

### SEQUENCE LISTING OR COMPUTER PROGRAM

Not Applicable

### FIELD OF THE INVENTION

This application relates to systems and methods for creating multiple logbooks in a computer application.

### BACKGROUND OF THE INVENTION

Computer Logbook applications are used to maintain records of events, actions, assets, data and observations. To record entries of dissimilar events, actions, assets, or observations, it becomes necessary to use separate logbooks, since these entries have unique characteristics and differences that cannot be captured in a single logbook application.

For example, a pilot logbook has data entry fields with characteristics specific to a flight. If the same pilot was an avid runner and wanted to keep track of his runs, he would not be able to use his pilot logbook application, but would have to use another application designed to keep track of his running activities. For keeping track of his vehicle mileage, or car maintenance, another application would be required. For keeping track of his expense, yet another application is needed.

Accordingly, it is desirable to provide a system and method of allowing the user to create many different kinds of logbooks that he/she may need and keep them organized from within one single computer application.

Since the requirements of a logbook vary widely depending on what is recorded in the logbook, it is desirable that this invention be versatile enough to allow the user to customize the logbook functionality to cover a wide variety of data input and entry format.

However, this invention should also make it relatively easy for the user to create logbooks for a variety of purposes, by providing a framework that does not require the user to define complex database tables, queries, and relationships.

### BRIEF SUMMARY OF THE INVENTION

The present invention provides systems and methods for creating and maintaining multiple logbooks in a single computer application. Each of these logbooks will be used to record and maintain a list of activities, assets, people, data, observation, etc.

For example, the present invention will allow a user to create a logbook for entering daily vehicle mileage, another logbook for running activities, another to keep track of his/her daily expenses, another for keeping track of household maintenance, another for keeping a list of addresses of people, and another to keep track of books read. All of these logbooks can be created and maintained in one computer application.

More particularly, the present invention provides a framework for quickly creating simple as well as complex logbooks by making available features and functions that are common to most logbooks.

The present invention provides yet another advantage by making it possible to create, in a single application, multiple logbooks of different design and usage, without requiring the user to purchase and install multiple computer applications or create accounts in multiple web-sites that are geared towards a single, specific logbook.

### BRIEF DESCRIPTION OF THE DRAWINGS

FIG. 1 illustrates the entity-relationship (ER) diagram that represents an embodiment of the present invention.

FIG. 2 illustrates the entity-relationship (ER) diagram of a sample example logbook titled “Exercise Logbook”.

FIG. 3 illustrates sample entries for the asset, “Shoe”, defined in the logbook titled “Exercise Logbook”.

FIG. 4 illustrates sample entries for the asset, “Bike”, defined in the logbook “Exercise Logbook”.

FIG. 5 illustrates sample entries for the route, “Route”, defined in the logbook “Exercise Logbook”.

FIG. 6 illustrates sample entries for the people, “Running mates”, defined in the logbook “Exercise Logbook”.

FIG. 7 illustrates sample entries for the activity, “Running”, defined in the logbook “Exercise Logbook”.

FIG. 8 illustrates sample entries for the activity, “Biking”, defined in the logbook “Exercise Logbook”.

FIG. 9 illustrates the entity-relationship (ER) diagram of a sample logbook titled “Music Library”.

FIG. 10 illustrates sample entries for the asset, “Songs”, defined in the logbook “Music Library”.

### DETAILED DESCRIPTION OF THE INVENTION

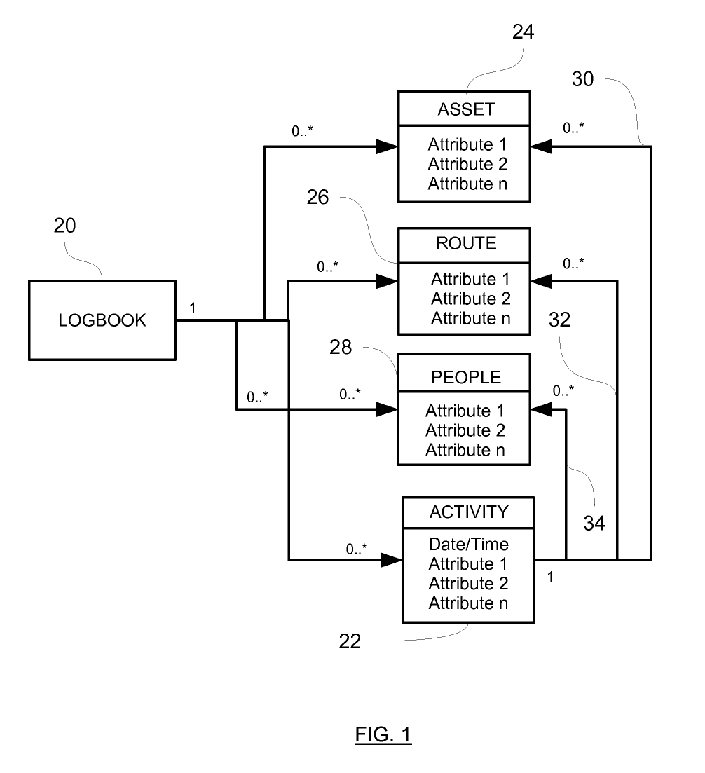

One embodiment of the present invention is illustrated in the Entity-Relationship (ER) diagram of FIG. 1. In more detail, there is shown an entity called logbook 20. Examples of logbooks are “Exercise Logbook”, “Vehicle Logbook”, “Household Expenses”, or “Music Library”.

Still referring to FIG. 1, the logbook consists of a plurality of entities called activity 22. The entity activity is an embodiment of activity, event, task, observation, work performed, etc., at a certain time and date. For the afore mentioned “Exercise Logbook”, the user may create one activity called “Running”, another activity called “biking”, and another activity called “Strength Training” The logbook “Vehicle Logbook” may have an activity called “Trip”. The activities defined within a single logbook are generally related (for example, they could be physical activities performed, such as “Running” and “Biking”, and “Strength Training”), but the present invention also allows for grouping unrelated activities within a single logbook.

In more detail, referring to FIG. 1, each activity has a date/time attribute. The date/time attribute records the date and time when each activity takes place. For example, referring to the previously mentioned activity, “Running”, the date/time attribute would hold the date and the time of each running activities performed by the user.

Still referring to FIG. 1, each activity has a plurality of attributes which are user defined. Each of these user-defined attribute is custom to the logbook that the user is creating and would allow the user to enter data that are pertinent to the activity. For example, for the previously mentioned activity “Running”, the user may choose to create attributes “Distance”, “Time Taken”, and “Remarks”.

Referring to FIG. 1, the logbook consists of a plurality of entity called asset 24. The entity asset is an embodiment of physical as well as virtual objects that are necessary, or of interest to the logbook. For example, in the previously mentioned “My Exercise Logbook”, the user may create an asset called “Shoe” to list shoes that the user uses for his running and biking activities. In the “Vehicle Logbook”, the asset could be “Car”.

Still referring to FIG. 1, each asset has a plurality of attributes which are user-defined. Each of these user-defined attribute is custom to the logbook that the user is creating and will allow the user to enter data that are pertinent to the asset. For example, for the asset, “Shoe”, the user may choose to create attributes called “Purchase price”, “Purchased from”, and “Brand name”.

Still referring to FIG. 1, the logbook consists of a plurality of entities called route 26. The entity route is an embodiment of commonly used road or path along which an activity takes place. For example, in the logbook “Exercise Logbook”, the user may define one or more route called “Running routes” as the road where she does her running

Still referring to FIG. 1, each route has a plurality of attributes which are user-defined. Each of these user-defined attribute is custom to the logbook that the user is creating and will allow the user to enter data that are pertinent to the route. For example, for the “Running Route” example, the user may choose to create attributes called “Difficulty (Hard/Moderate/Easy)”, “Distance (Miles)”, “Has restrooms (True/False)”, and “Google Map URL”.

Still referring to FIG. 1, the logbook consists of a plurality of entities called people 28. The entity people is an embodiment of person such as “Trainer”, “Instructor”, “Doctor”, “Partner”, “Friend”, etc.

Still referring to FIG. 1, each people has a plurality of attributes which are user-defined. Each of these user-defined attribute is custom to the logbook that the user is creating and would allow the user to enter data that are pertinent to the people. For example, the user may choose to create attributes called “Name”, “Address”, and “Certification”.

Still referring to FIG. 1, each activity may refer to (or be associated with) a plurality of asset 30. For example, the activity “Running” may require an asset called “Shoe”.

Still referring to FIG. 1, each activity may refer to (or be associated with) a plurality of route 32. For example, the activity “Running” may be run on a certain route called “Hebron Ave./Main St. loop”.

Still referring to FIG. 1, each activity may refer to (or be associated with) a plurality of people 34. For example, the activity “Running” may be run with a certain people called “Gary—my trainer”.

From the entities defined above, namely activity, asset, people, and route, many different kinds of logbooks can be designed to suit a wide variety of needs.

Not all of the entities (namely activity, asset, people, and route) need to be defined for every logbook. The present invention allows for a logbook to be created by defining a single entity, or some of the entities, or all of the entities. Some logbook design will require all the entities activity, asset, people, and route to be defined. Some may require three (for example, activity, asset and people), while others may require only two (for example, asset and route). Others may require only one of activity, asset, people, or route.

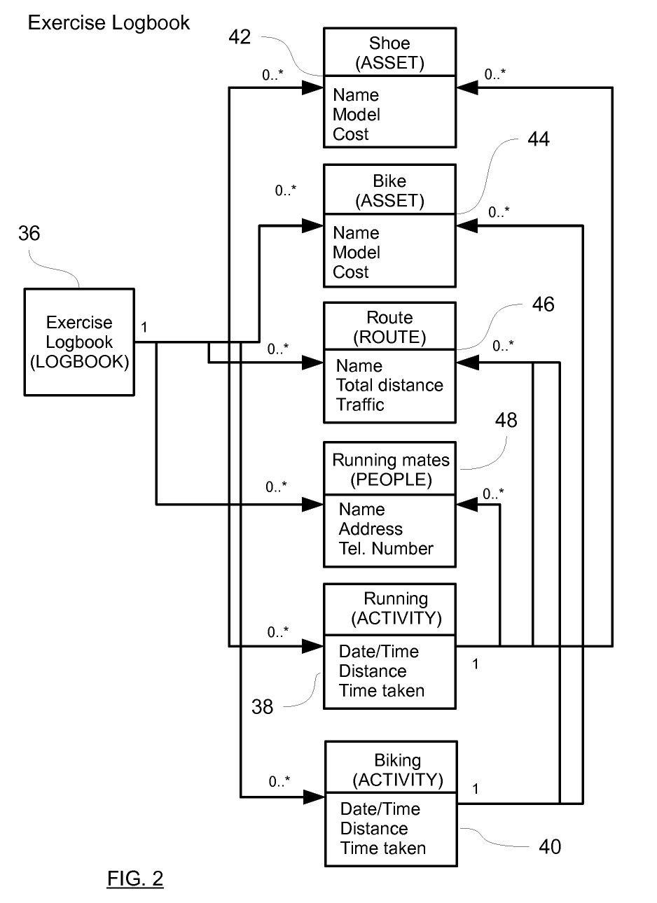

FIG. 2 shows an example of an Exercise logbook 36 that can be readily created using the current invention. This logbook comprises of the entities activity, asset, route, and people. There are two activities defined, Running 38 and Biking 40. Similarly, two assets are defined, Shoe 42 and Bike 44. The asset Shoe is used in both Running and Biking activities, whereas the asset Bike is used only in the activity Biking One route 46 is defined which are common to both activities Running and Biking Similarly, one people 48 is defined which may participate in either one activity (Running or Biking), or both activities (Running and Biking) Each entity has custom user-defined attributes.

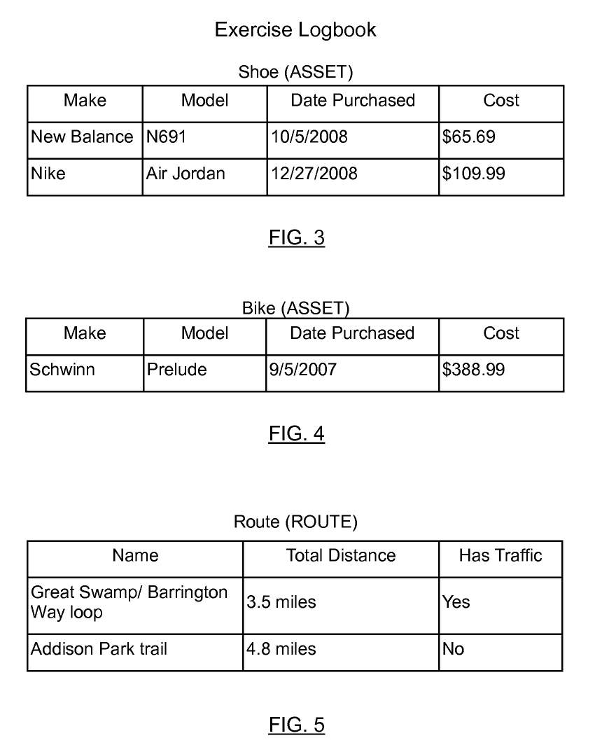

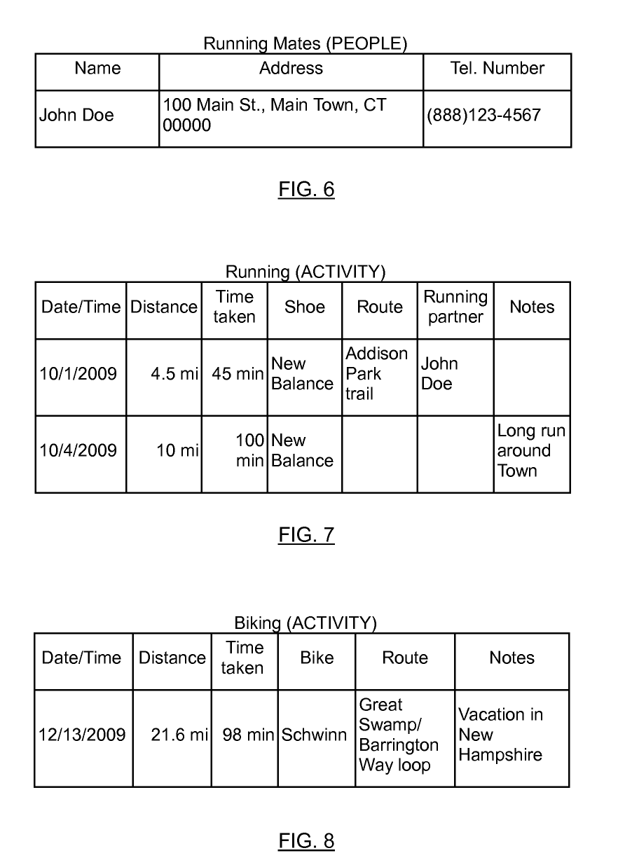

FIGS. 3, 4, 5, 6, 7, and 8 show the Exercise Logbook with a few samples of user-entered data.

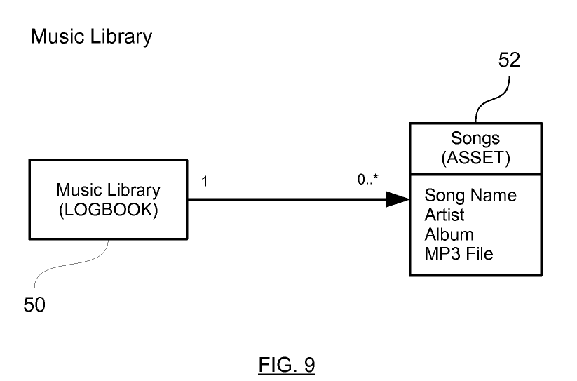

FIG. 9 shows an example of a Music Library 50, which keeps track of the user's MP3 files. This logbook comprises of one asset 52 called Songs. The asset, Songs, defines the attributes Song Name, Artist, Album, and MP3 File.

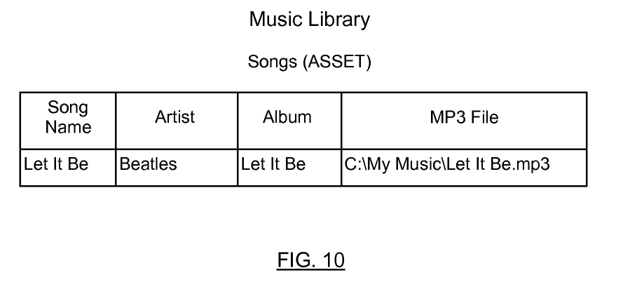

FIG. 10 shows a sample entry of the Music Library.

What is claimed is:

1. A method of creating a plurality of logbooks in a computer application, each logbook containing members selected from the group comprising:
a. a plurality of activity for keeping record of events, actions, and observations occurring at a specific date and time;
b. a plurality of asset for keeping record of physical objects and virtual objects;
c. a plurality of people for keeping record of person;
d. a plurality of route for keeping record of paths and roadways.

2. The method of claim 1, wherein said activity, further including members selected from the group consisting of said asset.

3. The method of claim 1, wherein said activity, further including members selected from the group consisting of said people.

4. The method of claim 1, wherein said activity, further including members selected from the group consisting of said route.
